(19) United States
(12) Patent Application Publication
(10) Pub. No.: US 2025/0052908 A1
(43) Pub. Date: Feb. 13, 2025

(54) IN-VEHICLE ELECTRONIC CONTROL UNIT AND POSITION ESTIMATION METHOD

(71) Applicant: Hitachi Astemo, Ltd., Hitachinaka-shi, Ibaraki (JP)

(72) Inventor: Toru KATO, Ibaraki (JP)

(73) Assignee: Hitachi Astemo, Ltd., Hitachinaka-shi, Ibaraki (JP)

(21) Appl. No.: 18/721,183

(22) PCT Filed: Dec. 24, 2021
(86) PCT No.: PCT/JP2021/048334

§ 371 Date: Jun. 17, 2024

(51) Int. Cl. G01S 19/07; G01S 19/23

(52) U.S. Cl. CPC G01S 19/07; G01S 19/23

(57) ABSTRACT

An in-vehicle electronic control unit includes: a positioning calculation unit that acquires GNSS information and acquires positioning information of an own vehicle; a vehicle movement detection unit that detects movement of the own vehicle; and an own vehicle movement determination unit that estimates movement while a vehicle system is stopped, in which the own vehicle movement determination unit determines whether the own vehicle has moved while the vehicle system is stopped, and based on a determination result as to whether the own vehicle has moved, determines whether the positioning calculation unit estimates a current position of the own vehicle by using a position of the own vehicle when the vehicle system is stopped.

### TECHNICAL FIELD

The present invention relates to an in-vehicle electronic control unit that estimates a position by GNSS positioning.

### BACKGROUND ART

Positioning using a global navigation satellite system (GNSS) includes a method that requires observation for a predetermined time from the start of positioning. For example, the precise point positioning (PPP) including multi-GNSS advanced demonstration tool for orbit and clock analysis (MADOCA) requires about 20 minutes as an initial convergence time because an actual positioning point is narrowed down from among a plurality of GNSS positioning candidate points by ambiguity resolution (AR) processing from the start of positioning until a predetermined positioning accuracy is obtained.

Background art of the present technical field includes the following prior art. PTL 1 (JP 2014-82539 A) discloses a vehicle control device including: a communication unit for transmitting/receiving information to/from an information processing device installed outside the vehicle; a control unit for controlling the vehicle control device on the basis of control information transmitted from the information processing device; and a position information acquisition unit for acquiring position information, wherein the position information acquisition unit acquires position information at parking start time when the vehicle starts parking, and acquires position information at a time point of receiving control information from the information processing device when the control unit is in a sleep state. When the position information acquisition units acquires the position information at the time of receiving the control information, the communication unit transmits position information having higher accuracy of the position information at the parking start time and the position information at the time of receiving the control information to the information processing device.

PTL 2 (JP 2009-85628 A) discloses a vehicle-mounted processing apparatus including: a direction information acquisition means for acquiring the travel direction information of one's own vehicle; a mirror-image determination means which performs image recognition processing on image information in the vicinity of one's own vehicle and determines whether or not a mirror image of one's own vehicle has been imaged; a power supply operation detection means for detecting on or off of a power supply; and travel direction correction means which, when the mirror-image determination means determines that a mirror image of one's own vehicle has been imaged within a predetermined determination period on the basis of the detection of power-on or power-off by the power supply operation detection means, corrects the travel direction information so that the travel direction of one's own vehicle is reversed.

### CITATION LIST

### Patent Literature

PTL 1: JP 2014-82539 A

PTL 2: JP 2009-85628 A

### SUMMARY OF INVENTION

### Technical Problem

Applying the above-described PPP positioning to an advanced drive assist system such as automatic driving requires about 20 minutes from the start of the vehicle until the advanced drive assist becomes available, and the function of the automobile is limited during that time, and thus the merchantability of the automobile is greatly impaired. Therefore, application of the positioning method requiring time for initial convergence to an automobile requires shortening of the initial convergence time.

An object of the present invention is to improve convenience of an automobile by application of a positioning method with a shortened initial convergence time to the automobile.

### Solution to Problem

A typical example of the invention disclosed in the present application is as follows. That is, an in-vehicle electronic control unit includes: a positioning calculation unit that acquires GNSS information and acquires positioning information of an own vehicle; a vehicle movement detection unit that detects movement of the own vehicle; and an own vehicle movement determination unit that estimates movement while a vehicle system is stopped, in which the own vehicle movement determination unit determines whether the own vehicle has moved while the vehicle system is stopped, and based on a determination result as to whether the own vehicle has moved, determines whether the positioning calculation unit estimates a current position of the own vehicle by using a position of the own vehicle when the vehicle system is stopped.

### Advantageous Effects of Invention

According to one aspect of the present invention, the self-position can be estimated with high accuracy in a short time from the start of the vehicle system, and the convenience of the automobile can be improved. Problems, configurations, and effects other than those described above will be made clear by the following description of embodiments.

### BRIEF DESCRIPTION OF DRAWINGS

FIG. 1 is a view illustrating a system configuration example of an automobile mounted with an electronic control unit of the present embodiment.

FIG. 2 is a flowchart of processing when the vehicle system is stopped of the present embodiment.

FIG. 3 is a flowchart of processing when the vehicle system is started of a first embodiment.

FIG. 4 is a flowchart of processing when the vehicle system is started of a second embodiment.

### DESCRIPTION OF EMBODIMENTS

Embodiments according to the present invention will be described below.

### First Embodiment

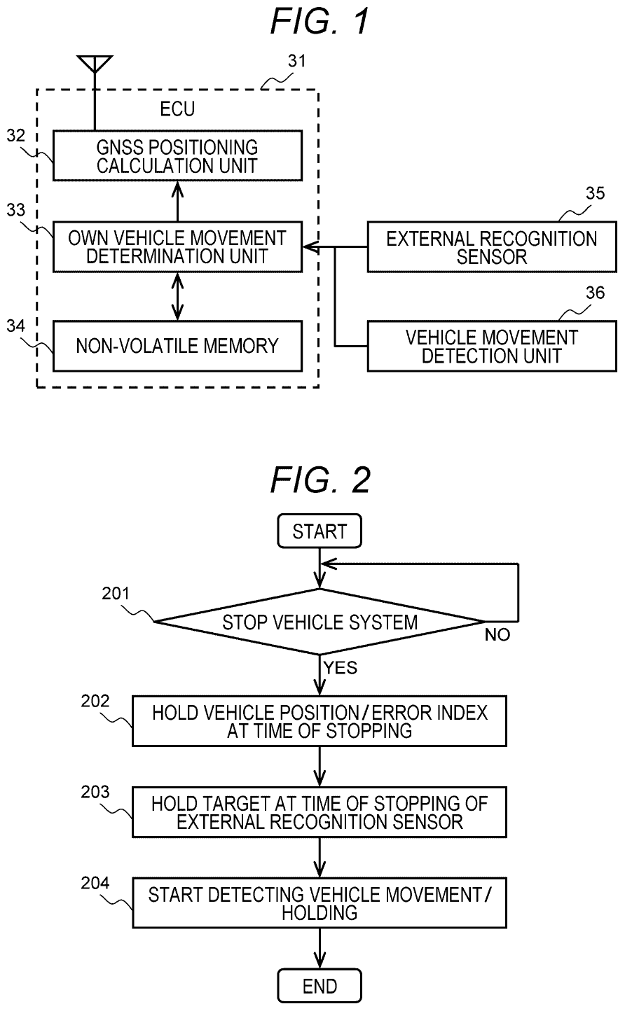

FIG. 1 is a view illustrating a system configuration example of an automobile mounted with an electronic control unit 31 of the present embodiment.

The electronic control unit (ECU) 31 includes a GNSS positioning calculation unit 32, an own vehicle movement determination unit 33, and a non-volatile memory 34.

The own vehicle movement determination unit 33 is connected with an external recognition sensor 35 and a vehicle movement detection unit 36 that are grounded to the vehicle, and receives position information of a target outside the vehicle and vehicle movement detection information.

The external recognition sensor 35 is a sensor that acquires a situation outside the vehicle, and radar, Lidar, a camera, or the like can be used.

The non-volatile memory 34 stores the position of the vehicle when the vehicle system is stopped and target information of the external recognition sensor 35.

When the vehicle system is started, the own vehicle movement determination unit 33 determines whether the movement amount of the vehicle during stopping exceeds a threshold value with reference to the position of the vehicle when the vehicle system is stopped and the target information of the external recognition sensor 35 held in the non-volatile memory 34.

The GNSS positioning calculation unit 32 calculates the position of the own vehicle by a signal received from a global navigation satellite system (GNSS) satellite. The GNSS positioning calculation unit 32 calculates the position of the own vehicle with high accuracy by precise point positioning (PPP), for example. When the own vehicle movement determination unit 33 determines that the movement amount of the vehicle during stopping is smaller than the threshold value, the GNSS positioning calculation unit 32 narrows down the solution of the PPP positioning calculation by the vehicle position information held in the non-volatile memory 34, and causes the PPP positioning calculation to initially converge at a high speed. When the vehicle movement amount is larger than the threshold value, the GNSS positioning calculation unit 32 performs positioning calculation without using the vehicle position information held in the non-volatile memory 34.

The own vehicle position calculated by the GNSS positioning calculation unit 32 is input to a position estimation unit (not illustrated) of the electronic control unit 31. The position estimation unit calculates an own vehicle position and a self-position estimation error by combined use of a plurality of methods such as an own vehicle position calculated by the GNSS positioning calculation unit 32, a measurement result of acceleration by an inertial measurement unit (IMU), dead reckoning using a measurement result of rotation of a tire, and map matching using map information.

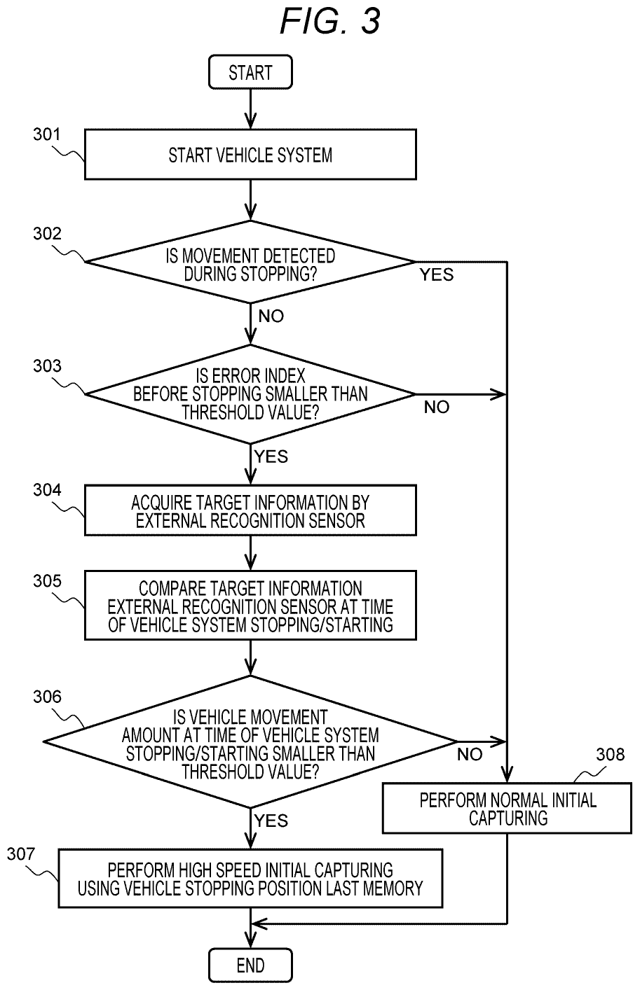

The vehicle movement detection unit 36 detects vehicle movement while the vehicle system is stopped, and for example, an immobilizer that detects acceleration of the vehicle, an around view camera that recognizes a white line around the vehicle, or the like can be used. Note that in a case of not using the determination of step 302 in FIG. 3, it is not necessary to provide the vehicle movement detection unit 36.

The electronic control unit 31 includes a calculation device, a storage device, and a network interface.

The calculation device is a processor (e.g., a CPU) that executes a program stored in the storage device. The calculation device operates as a functional unit that provides various functions by executing a predetermined program.

The storage device includes a non-volatile storage area and a volatile storage area. The non-volatile storage area includes a program area for storing a program executed by the calculation device and a data area for temporarily storing data used when the calculation device executes the program.

The network interface is connected to another electronic control unit via an in-vehicle network such as CAN.

FIG. 2 is a flowchart of processing when the vehicle system is stopped of the present embodiment.

Step 201: Stopping of the vehicle system is determined by an IGN signal, and the processing when the vehicle system is stopped below is started when the vehicle system is stopped.

Step 202: The own vehicle movement determination unit 33 holds the vehicle position when the vehicle system is stopped and its error index information into the non-volatile memory 34. For example, accuracy information output from the GNSS positioning calculation unit 32 or a self-position estimation error calculated by the position estimation unit of the electronic control unit 31 can be used.

Step 203: The own vehicle movement determination unit 33 holds, in the non-volatile memory 34, target information when the vehicle system is stopped acquired by the external recognition sensor 35.

Step 204: Vehicle movement detection processing while the vehicle system is stopped is started. In the vehicle movement detection processing, the vehicle movement detection unit 36 detects vehicle movement while the vehicle system is stopped, and holds vehicle movement detection information upon detecting the vehicle movement. For example, in the vehicle movement detection unit 36, the immobilizer detects and holds the acceleration of the vehicle, and the around view camera recognizes and holds the white line around the vehicle. Note that the detected acceleration may be held as it is, or a movement amount in which the acceleration is integrated may be held. The movement amount may be calculated by integrating the held acceleration value when the vehicle system is started.

FIG. 3 is a flowchart of processing when the vehicle system is started of a first embodiment.

Step 301: When the vehicle system is started, the processing at the time of starting the vehicle system below is started.

Step 302: The vehicle movement detection information detected and held in step 204 is read from the vehicle movement detection unit 36, and based on whether the read vehicle movement detection information indicates movement of equal to or greater than a predetermined threshold value, it is determined whether movement of the vehicle has been detected while the vehicle system is stopped. This predetermined threshold value may be set to about an error of the position information of the vehicle.

Step 303: It is determined whether the error index information of the vehicle position when the vehicle system is stopped held in step 202 is smaller than a predetermined threshold value. This predetermined threshold value may be set to about an initial position range (e.g., an existence range of a candidate point at the start of PPP positioning) of GNSS positioning.

Step 304: Current target information around the vehicle is acquired by using the external recognition sensor 35 same as that in step 203.

Step 305: The target information acquired by the external recognition sensor 35 when the vehicle system is stopped in step 203 is compared with the target information acquired by the external recognition sensor 35 when the vehicle system is started in step 304, and the vehicle movement amount while the vehicle is stopped is calculated.

Step 306: It is determined whether the vehicle movement amount calculated in step 305 is smaller than a predetermined threshold value. This predetermined threshold value may be set to be smaller than the initial position range of the GNSS positioning used in step 303.

Step 307: In a case where it is determined in step 306 that the vehicle movement amount is smaller than the threshold value and there is no vehicle movement while the vehicle system is stopped, the GNSS positioning calculation unit 32 performs positioning calculation using the vehicle position information when the vehicle system is stopped held in step 202. For example, a circle centered on the vehicle position information when the vehicle system is stopped and having the error index when the vehicle system is stopped as a radius is set as an existence range of the candidate point at the time of start of PPP positioning. This can narrow down the correct answer from the GNSS positioning candidate points in a narrower range than normal GNSS positioning candidate points, and therefore high-speed initial convergence of positioning calculation becomes possible.

Step 308: In a case where movement of the vehicle is detected while the vehicle system is stopped in step 302, or in a case where it is determined in step 303 that the error information of the position when the vehicle system is stopped is larger than the threshold value set as the error amount, or in a case where it is determined in step 306 that the vehicle movement amount is larger than the threshold value and vehicle movement is present while the vehicle system is stopped, the GNSS positioning calculation unit 32 performs positioning calculation without using the vehicle position information when the vehicle system is stopped held in step 202.

In the present embodiment, whether to perform high-speed initial capturing is determined using the results of the three determinations of steps 302, 303, and 306, but whether to perform high-speed initial capturing may be determined using the results of one or two of these determinations.

As described above, according to the first embodiment of the present invention, it is possible to cause PPP positioning calculation to initially converge at high speed by determining vehicle movement while the vehicle is stopped and using the vehicle position information when the vehicle is stopped.

### Second Embodiment

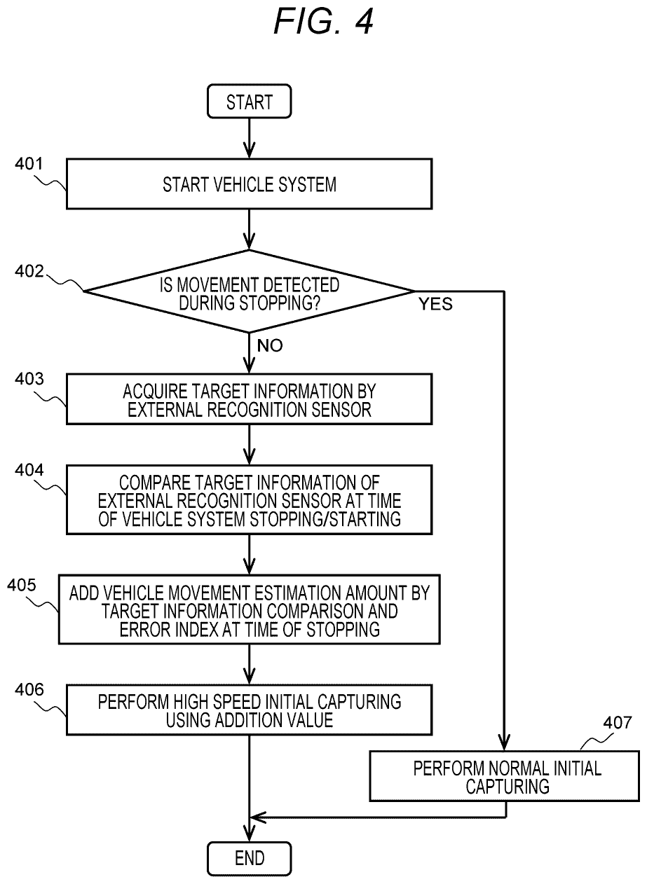

FIG. 4 is a flowchart of processing when the vehicle system is started of a second embodiment.

Step 401: When the vehicle system is started, the processing at the time of starting the vehicle system below is started.

Step 402: The vehicle movement detection information detected and held in step 204 is read from the vehicle movement detection unit 36, and based on whether the read vehicle movement detection information indicates movement of equal to or greater than a predetermined threshold value, it is determined whether movement of the vehicle has been detected while the vehicle system is stopped. This predetermined threshold value may be set to about an error of the position information of the vehicle.

Step 403: Target information around the vehicle is acquired by using the external recognition sensor 35 same as that in step 203.

Step 404: The target information acquired by the external recognition sensor 35 when the vehicle system is stopped in step 202 is compared with the target information acquired by the external recognition sensor 35 when the vehicle system is started in step 304, and the vehicle movement amount while the vehicle is stopped is calculated.

Step 405: The vehicle movement amount calculated in step 404 and the error index information of the vehicle position when the vehicle system is stopped held in step 202 are added. This addition value represents a range, including an error, in which the vehicle is likely to exist when the vehicle system is started.

Step 406: The GNSS positioning calculation unit 32 performs positioning calculation using the addition value calculated in step 405. For example, a circle centered on the vehicle position information when the vehicle system is stopped and having the calculated additional value as a radius is set as an existence range of the candidate point at the time of start of PPP positioning. This can narrow down the correct answer from among a plurality of GNSS positioning candidate points, and high-speed initial convergence of positioning calculation becomes possible.

Step 407: In a case where movement of the vehicle is detected while the vehicle system is stopped in step 402, the GNSS positioning calculation unit 32 performs positioning calculation without using the vehicle position information when the vehicle system is stopped held in step 202.

In the second embodiment, the configuration and the processing procedure other than the above description are the same as those of the first embodiment described above, and the description thereof is omitted.

As described above, according to the second embodiment of the present: invention, it is possible to cause PPP positioning calculation to initially converge at high speed by determining vehicle movement while the vehicle is stopped more easily than the first embodiment and using the vehicle position information when the vehicle is stopped.

As described above, since the electronic control unit 31 of the embodiments of the present invention includes the GNSS positioning calculation unit 32 that acquires GNSS information and acquires positioning information of the own vehicle, the vehicle movement detection unit 36 that detects movement of the own vehicle, and the own vehicle movement determination unit 33 that estimates movement while the vehicle system is stopped, and the own vehicle movement determination unit 33 determines whether the own vehicle has moved while the vehicle system is stopped, and based on a determination result as to whether the own vehicle has moved, determines whether the GNSS positioning calculation unit 32 estimates a current position of the own vehicle by using a position of the own vehicle when the vehicle system is stopped, it is possible to estimate the self-position with high accuracy in a short time from the start of the vehicle system, and it is possible to improve the convenience of the automobile. For example, in a case of using PPP positioning calculation, it takes about 20 minutes from the start of the vehicle system until the high-accuracy position information is obtained, and during that time, the function of the automobile is limited, and meanwhile, according to the electronic control unit 31 of the present embodiment, since the initial convergence range is limited by the position information when the vehicle system is stopped based on the determination result of movement of the vehicle while the vehicle system is stopped, high-accuracy position information can be obtained in a short time, advanced drive assistance becomes possible in a short time after the start of the vehicle system, and the convenience of the vehicle can be improved.

Note that the present invention is not limited to the above-described embodiments, and includes various modifications and equivalent configurations within the spirit of the appended claims. For example, the above-described embodiments have been described in detail for easy understanding of the present invention, and the present invention is not necessarily limited to those having all the described configurations. A part of the configuration of a certain embodiment may be replaced with the configuration of another embodiment. The configuration of another embodiment may be added to the configuration of a certain embodiment. A part of the configuration of each embodiment may be added, deleted, or replaced with another configuration.

Some or all of the above-described configurations, functions, processing units, processing means, and the like may be implemented by hardware by designing with an integrated circuit, for example, or may be implemented by software by a processor interpreting and executing a program for implementing each function.

Information such as a program, a table, and a file for implementing each function can be stored in a storage device such as a memory, a hard disk, and a solid state drive (SSD), or a recording medium such as an IC card, an SD card, and a DVD.

Control lines and information lines that are considered to be necessary for description are illustrated, and not necessarily all control lines and information lines necessary for implementation are illustrated. In practice, it may be considered that almost all the configurations are connected to one another.

1. An in-vehicle electronic control unit comprising:
a positioning calculation unit that acquires GNSS information and acquires positioning information of an own vehicle;
a vehicle movement detection unit that detects movement of the own vehicle; and
an own vehicle movement determination unit that estimates movement while a vehicle system is stopped,
wherein the own vehicle movement determination unit
determines whether the own vehicle has moved while the vehicle system is stopped, and
based on a determination result as to whether the own vehicle has moved, determines whether the positioning calculation unit estimates a current position of the own vehicle by using a position of the own vehicle when the vehicle system is stopped.

2. The in-vehicle electronic control unit according to claim 1, wherein the positioning calculation unit estimates a current position of the own vehicle by PPP positioning calculation.

3. The in-vehicle electronic control unit according to claim 1, wherein
the own vehicle movement determination unit
determines whether the vehicle movement detection unit has detected movement of the own vehicle by equal to or greater than a predetermined threshold value while the vehicle system is stopped,
determines that the positioning calculation unit estimates a current position of the own vehicle without using a position of the own vehicle when the vehicle system is stopped in a case where movement of the own vehicle by equal to or greater than a predetermined threshold value is detected, and
determines that the positioning calculation unit estimates a current position of the own vehicle using a position of the own vehicle when the vehicle system is stopped in a case where movement of the own vehicle by equal to or greater than a predetermined threshold value has not been detected.

4. The in-vehicle electronic control unit according to claim 1, wherein
the in-vehicle electronic control unit calculates a position error of the own vehicle, and
the own vehicle movement determination unit
determines whether the calculated position error is smaller than a predetermined threshold value,
determines that the positioning calculation unit estimates a current position of the own vehicle without using a position of the own vehicle when the vehicle system is stopped in a case where the calculated position error is larger than a predetermined threshold value, and
determines that the positioning calculation unit estimates a current position of the own vehicle using a position of the own vehicle when the vehicle system is stopped in a case where the calculated position error is smaller than a predetermined threshold value.

5. The in-vehicle electronic control unit according to claim 1, wherein
the own vehicle movement determination unit
compares a position of the own vehicle calculated from a target recognized by an external recognition sensor when the vehicle system is stopped with a position of the own vehicle calculated from a target recognized by the external recognition sensor when the vehicle system is started subsequently, and determines whether the own vehicle has moved while the vehicle system is stopped,
determines that the positioning calculation unit estimates a current position of the own vehicle without using a position of the own vehicle when the vehicle system is stopped in a case where a movement amount of the own vehicle while the vehicle system is stopped is larger than a predetermined threshold value, and
determines that the positioning calculation unit estimates a current position of the own vehicle using a position of the own vehicle when the vehicle system is stopped in a case where a movement amount of the own vehicle while the vehicle system is stopped is smaller than a predetermined threshold value.

6. The in-vehicle electronic control unit according to claim 1, wherein
the in-vehicle electronic control unit calculates a position error of the own vehicle, and
the own vehicle movement determination unit
determines whether the vehicle movement detection unit has detected movement of the own vehicle by equal to or greater than a predetermined threshold value while the vehicle system is stopped,
determines that the positioning calculation unit estimates a current position of the own vehicle without using a position of the own vehicle when the vehicle system is stopped in a case where movement of the own vehicle by equal to or greater than a predetermined threshold value is detected,
determines whether the calculated position error is smaller than a predetermined threshold value in a case where movement of the own vehicle by equal to or greater than a predetermined threshold value has not been detected,
determines that the positioning calculation unit estimates a current position of the own vehicle without using a position of the own vehicle when the vehicle system is stopped in a case where the calculated position error is larger than a predetermined threshold value,
in a case where the calculated position error is smaller than a predetermined threshold value, compares a position of the own vehicle calculated from a target recognized by an external recognition sensor when the vehicle system is stopped with a position of the own vehicle calculated from a target recognized by the external recognition sensor when the vehicle system is started subsequently, and determines whether the own vehicle has moved while the vehicle system is stopped,
determines that the positioning calculation unit estimates a current position of the own vehicle without using a position of the own vehicle when the vehicle system is stopped in a case where a movement amount of the own vehicle while the vehicle system is stopped is larger than a predetermined threshold value, and
determines that the positioning calculation unit estimates a current position of the own vehicle using a position of the own vehicle when the vehicle system is stopped in a case where a movement amount of the own vehicle while the vehicle system is stopped is smaller than a predetermined threshold value.

7. The in-vehicle electronic control unit according to claim 1, wherein the positioning calculation unit estimates a current position of the own vehicle by using, as an existence range of a candidate point at a time of start of positioning, a value in which a position error when the vehicle system is stopped and a movement amount while the vehicle system is stopped are added.

8. A position estimation method executed by an in-vehicle electronic control unit, wherein
the in-vehicle electronic control unit includes
a positioning calculation unit that acquires GNSS information and acquires positioning information of an own vehicle,
a vehicle movement detection unit that detects movement of the own vehicle, and
an own vehicle movement determination unit that estimates movement while a vehicle system is stopped, and
in the position estimation method,
the own vehicle movement determination unit determines whether the own vehicle has moved while the vehicle system is stopped,
based on a determination result as to whether the own vehicle has moved, the own vehicle movement determination unit determines whether the positioning calculation unit estimates a current position of the own vehicle by using a position of the own vehicle when the vehicle system is stopped, and
the positioning calculation unit estimates a current position of the own vehicle by using a position of the own vehicle when the vehicle system is stopped in accordance with determination by the own vehicle movement determination unit.
